(19) United States
(12) Patent Application Publication
(10) Pub. No.: US 2013/0168306 A1
(43) Pub. Date: Jul. 4, 2013

(54) Hydraulic Fracturing Water Filter

(71) Applicant: Mark Crawford, (US)

(72) Inventor: Mark Crawford, (US)

(21) Appl. No.: 13/342,666

(22) Filed: Jan. 3, 2012

(51) Int. Cl. B01D 36/04

(52) U.S. Cl. 210/295

(57) ABSTRACT

The invention is a portable, redundant, barrier-based continuous filter system which employs a two-stage filter. The first stage is a mesh strainer to eliminate sticks and other large debris, and then a second stage consisting of a series of barrier plates which abruptly change the direction of the fluid and thereby encourages sand and other particles to settle at the bottom of the tank. A two-filter system is disclosed that allows for continuous cleaning by employing two filter tanks which alternate between filtering and cleaning cycles. The two tanks are connected with valves so that the fluid first is filtered by one tank, and then switched to the second tank when the first tank requires cleaning.

### CROSS-REFERENCES TO RELATED APPLICATIONS

None.

### STATEMENT REGARDING FEDERALLY SPONSORED RESEARCH AND DEVELOPMENT

None.

### The Names of The Parties To A Joint Research Agreement

None.

### INCORPORATION-BY-REFERENCE OF MATERIAL SUBMITTED ON A COMPACT DISC

None.

### BACKGROUND OF THE INVENTION

1. Field of the Invention

The invention pertains to water filtering for drilling fluids.

2. Background Art

Oil well drilling and hydraulic fracturing (“fracking”) operations often require sources of water to provide lubrication of the drilling and pressurize fractures. To be effective, this water need not be pure, but it does have to be free of debris, sand and formation cuttings.

The fluid is often recycled through the system, first pumped down into a well, and then pressurized to come back up, where it is kept in holding tanks to be reused. Debris in the drilling fluid settles to the bottom of a holding tank after a period of time which varies in practice. An operator can pump dirtier water through the system, but risks complications due to an errant tree limb or other similar debris getting stuck and causing problems somewhere along the way.

Oil well operators seek to minimize downtime and the need for large holding tanks As already stated, the drilling fluid needs only to be pure of large debris and sand, so temporary holding tanks are suitable for the process of simply allowing the debris to settle out of the water. However, such a technique is imprecise, and often goes awry.

Oil well operators, drillers and fracking teams need a method of quickly filtering out the debris from drilling fluid.

### BRIEF SUMMARY OF THE INVENTION

The invention is a portable, redundant, obstacle-based continuous filter system which employs two filters which alternate between filtering and cleaning cycles in order to maintain continuous cleaning. The filters comprise two stages. The first stage is a mesh strainer to eliminate sticks and other large debris, and then a second stage consisting of a series of obstacles which abruptly changes the direction of the fluid and thereby encourages sand and other particles to settle at the bottom of the tank. The two tanks are connected with valves so that the fluid first is filtered by one tank, and then switched to the second tank when the first tank requires cleaning.

### BRIEF DESCRIPTION OF THE SEVERAL VIEWS OF THE DRAWING(S)

FIG. 1—Sectional view of the filter tank.

FIG. 2—Top view of the invention.

FIG. 3—Side view of the invention.

### DETAILED DESCRIPTION OF THE INVENTION

According to the present invention, the foregoing and other objects and advantages are attained by the filter system as shown in the figures.

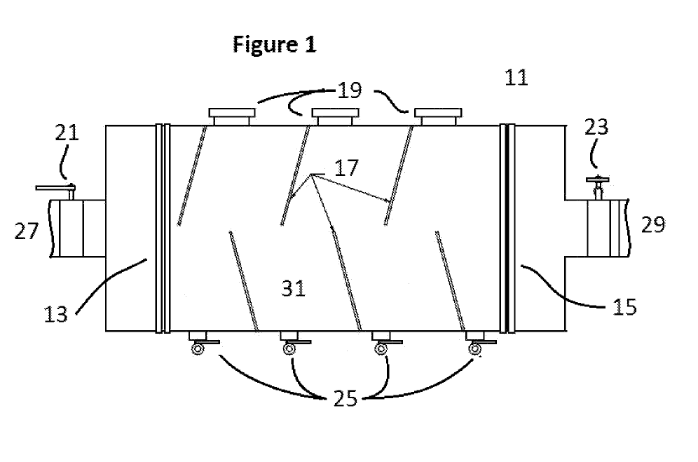

As shown in the FIG. 1, the system uses a two-stage filter 11 inside a cylindrical tank 31 with end caps that reduce to 10″ outlets 27, 29. The tank 31 is eight-foot long and 36″ in diameter. The first stage includes a 36″ diameter strainer 13 made of PS/CR, 0.063 woven mesh through which all of the liquid must flow, and eliminates all large debris.

The second stage of the filter 11 is a series of plates 17A, 17B that are mounted in the tank in such a way that particulates tend to fall out of the flow of the fluid. As shown in FIG. 1, the lower plates 17B extend from the floor of the tank 31, forming an angled chord across the cylinder. The raised plates 17A extend down from the cylinder's ceiling, forming the same shape.

The angle and shape of the plates are designed to force a sudden change of direction of the flowing liquid, causing heavier particles to be caught by the lower plates 17B and collected on the floor of the tank 31. The invention works best when the plates are angled, but still work even when mounted perpendicular to the cylinder tank wall. The length to which each plate interrupts the flow is also variable. FIG. 1 shows the invention as it is used currently, but the number and spacing of plates, tank length, and other such details can be modified without departing from the spirit of the invention.

During operation, fluid enters the tank 31 through an entrance valve 21, through the strainer filter 13, winds through the upper and lower plate filters 17A, 17B, and leaves through an exit valve 23.

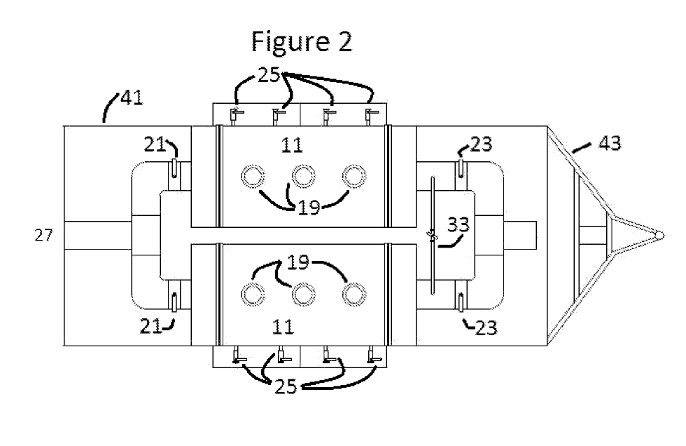

The embodiment of the invention as typically used comprises two of the prior-described tanks 11 in parallel, as shown in FIG. 2, along with a trailer 43 to allow for easy transport. In this configuration, either tank can be placed into service by opening its inlet valve 21. A cross-feed connection and control valve 33 is provided so one tank can feed the other during cleaning without a second source of fluid. The invention as built currently also has three six-inch plugs 19 that are used to wash the tank interior 31, and a drain valve 25 is located under each plate section to allow an operator to clean out a section at a time.

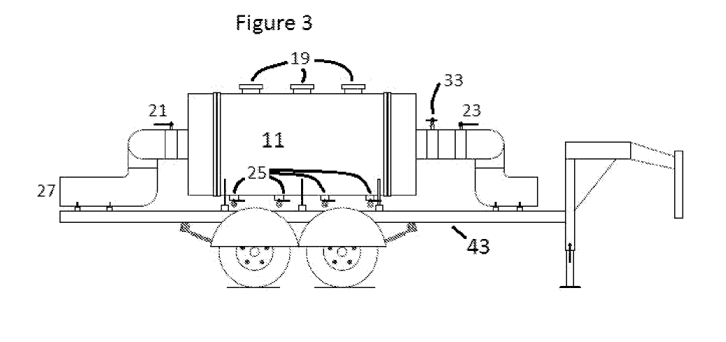

FIG. 3 is a side view of the trailer 43 with a two-tank configuration, and shows the drainage valves 25, the single input pipe 27 that feeds the inlet valves 21 of both tanks, (depending on which inlet valve is open), and the cross-connection valve.

In operation, a user can switch the filtering tank at regular intervals, or monitor the pressure in and out of the filtering tank 11 by the use of pressure readings going into and out of the tank. These readings can be taken at the inlet valves 21 and outlet valves 23.

Another embodiment of the filter system uses only one tank 11. The one-tank filter works just as well as two, though it must be periodically stopped for cleaning

While this invention has been described as it is currently built, the invention is not limited to the disclosed embodiments, but can be employed in various equivalent arrangements included within the spirit and scope of the claims.

1) A filter system for hydraulic fracturing comprising: at least one filter tank with a two-stage filter, wherein fluid to be filtered enters an inlet portal on one end of the tank, travels through a debris filter and then a sediment deposit filter while in the filter tank, and leaves the tank from an outlet portal on the opposite end of the inlet portal, said debris filter comprising a mesh strainer mounted in the path of the fluid flow, and said sediment deposit filter comprising barrier plates installed in the tank, such plates mounted alternatively on the bottom interior and then top interior of the filter tank, such that fluid flowing through the filter tank must go over and then under the plate barriers.
A filter system as in claim 1 that has at least two filter tanks connected in parallel with their inlet portals connect to the same fluid source, and their outlet portals are connected to the same drain, and valves on the inlet portals control whether one or more filter tanks to which they are connected are in operation at any given time.
A filter system as in claim 1 in which each filter tank has individual drain valves so that each drain valve will empty the section of the filter tank delineated by two plate barriers mounted on the bottom of the tank.
